(19) United States
(12) Patent Application Publication
(10) Pub. No.: US 2026/0157839 A1
(43) Pub. Date: Jun. 11, 2026

(54) A SENSOR SYSTEM AND METHOD FOR MEASURING HEALTH IN MULTIPLE VERTEBRATE ANIMALS IN HOME CAGES AND HOUSING RACKS

(71) Applicant: Olden Labs, PBC., Allston, MA (US)

(72) Inventors: Michael Florea, Allston, MA (US); Pratomo Alimsijah, Palo Alto, CA (US); Michal Kaca, Pacifica, CA (US); Noah Weber, Mill Valley, CA (US)

(21) Appl. No.: 19/180,868

(22) Filed: Apr. 16, 2025

Related U.S. Application Data
(60) Provisional application No. 63/634,711, filed on Apr. 16, 2024.

(51) Int. Cl. A61D 99/00

(52) U.S. Cl. CPC A61D 99/00

(57) ABSTRACT

A vertebrate monitoring system and method for a smart cage that has at least one sensor array disposed on the smart cage over monitored vertebrate animals living within the smart cage. At least one sensor is disposed on the at least one sensor array and is designed to, in situ, monitor and collect data from at least one or more of environmental conditions within the smart cage, vertebrate animal physiology, vertebrate animal activity, and vertebrate animal performance levels. At least one video camera assembly is disposed to record top-down views of the smart cage interior and elements therein. At least one light source is designed to illuminate the smart cage interior at intensities and color ranges designed for the at least one camera assembly. At least one audio sensor and audio recorder are designed to collect sounds originating from within the smart cage.

### CROSS-REFERENCE TO RELATED APPLICATIONS

This application claims priority to and the benefit of U.S. application 63/634,711 titled A SENSOR SYSTEM AND METHOD FOR MEASURING HEALTH IN MULTIPLE VERTEBRATE ANIMALS IN HOME CAGES AND HOUSING RACKS filed on Apr. 16, 2024, which is incorporated herein by reference in its entirety.

### FIELD OF THE INVENTION

The invention relates to laboratory animal housing, electronic monitoring of health, and of housing conditions and identification of individual animals from a group of multiple animals.

### BACKGROUND

The current standard in biomedical research is to maintain animals (mice, rats, and other small mammals) in individual cages that are equipped with ventilation (individually ventilated cages) and housed in a rack—termed Individually Ventilated Cages (IVC racks). Additionally, most cages contain food, water, and bedding. Individual ventilation is necessary because laboratory animals produce noxious smells (pheromones, urine, and feces) and associated allergens that reduce air quality for both animals and human operators. Without appropriate ventilation, the animal housing room quickly becomes uninhabitable.

IVC cages are also optimized for easy cleaning and cannot be changed for automated cleaning processes. Therefore, it is preferable to keep laboratory animals in IVC cages, except for short duration testing (a few hours to a few days).

Additionally, most animals are housed in groups. Rodents as well as other mammalian lab animals are social and can suffer from depression, hypothermia, and stress when housed individually. For this reason, AAALAC accreditation program for animal research guidelines mandate solitary housing to be limited to a few weeks or less (unless exceptional circumstances require). Group housing, however, makes it difficult to track and estimate the health of any individual animal using automated methods. Of all existing systems, only RFID implants can achieve this robustly and over extended periods. However, RFID-based systems require costly RFID implants and can only return movement and temperature data at a low spatial resolution.

When animals are used for experiments, particularly behavior and physiology experiments, measuring parameters such as activity, strength, learning speed, frequency of fighting, grooming, etc., they are normally removed from their home cage and placed in a specialized test setup to perform the measurement. This removal can perturb animals, causing them stress due to handling and moving to an unfamiliar environment. This stress can substantially change physiology and impact treatment, leading to irreproducible results. Furthermore, because testing requires manual handling (sometimes even as part of the measurement itself) the specific human operator performing measurements can skew the resulting data, leading to further irreproducibility. Finally, because each measurement must be performed sequentially, and animals trained in new testing environments, the testing process itself can be time-consuming, laborious, and expensive.

A solution to these problems is to design a measurement device that can measure the health of animals automatically, in their home cage. Additionally, the measurement device must be able to measure the health of individual animals in group-house settings. Furthermore, the home cage must be ventilated to foster long-term use. Finally, the measurement device and the home cage must fit into an existing housing rack and be compatible with existing cages to avoid the cost of replacing racks, cages, and cage washing equipment.

While there are solutions that have describe health measurement systems (smart cages) that fulfill one or a few of the above conditions, no device has been observed that fulfills all these conditions and enables collection of “phenomics” data (defined as multidimensional health and behavioral data collected substantially continuously over the entire experimental period). Broadly, existing solutions can be divided into 1) metabolic cages and testing setups, 2) video-based non-IVC monitoring systems, 3) non-video-based IVC monitoring systems, and 4) basic video monitoring in IVC racks. Test setups allow measurement of multiple parameters of individual mice but are designed for one-shot or short-term measurements only and cause stress as described above. Non-video-based IVC monitoring systems use indirect methods to track the activity of animals, such as RFID implants, motion detectors, etc. —but are unable to return much health information beyond a few basic parameters. Furthermore, since RFID implants do not provide a visual feed, manual daily health checks will still be necessary. Then, there are video-based non-IVC cage monitoring systems, which use a video camera and a home cage outside of IVC racks. These systems are also time-limited but due to practical reasons, maintenance of animals outside of IVC racks results in frequent cleaning requirements and requires ample space and reduces air quality for both human operators and animals.

As a result, for practical reasons, only small cohorts of animals can be measured and for a short amount of time. Finally, there are a few video-based home-cage monitoring systems that are compatible with IVC racks. However, the existing systems suffer from two major drawbacks. Either they use custom-designed IVC racks and cages, requiring a large investment to replace existing rack systems and cage washing systems (cage washing robots are specific to certain cages and may cost ˜$1-2M to replace as of the time of filing).

Alternatively, existing systems allow the use of fully existing IVC racks and cages, but they fail to provide meaningful data due to occlusion and side-ways camera angles. As a result, these IVC racks are unable to provide long-term health and tracking data in multi-housed animals. This is a drawback, since housing of animals solitarily limits observation periods to a few weeks, fails to provide data on social behavior, and reduces throughput as only one animal can be measured per cage, as opposed to five. As a result, no observed system provides the minimum solution necessary to enable the collection of phenomics data in home-cage animal monitoring, and health tracking in IVC racks. Therefore, there is a need in the market for an improved solution for animal monitoring and health tracking in IVC racks.

### SUMMARY OF THE INVENTION

Disclosed is a smart cage system (DOME Assembly™—Digital Online Monitoring Equipment) assembly, which herein after can be referred to as dome assembly, that is compatible with existing IVC racks, can use existing cages, can track individual animals in a group-housed setting (in conjunction with OldenTag™ systems), and can return information and data regarding tens of health metrics and several cage condition metrics of vertebrate animals. Dome assemblies include electronic monitoring equipment that fit into existing rodent racks to allow 24/7 video and audio recording and production of stimuli (sound, light, heat) in home cages to estimate the health of animals and the condition of cages.

Dome assemblies are electronic monitoring equipment that fit into existing rodent racks to allow continuous (24/7) video and audio recording and production of stimuli (sound, light, heat) in animal cages to estimate the health of animals and the condition of the cage.

The uniqueness and core inventive concept: Digital Online Monitoring Equipment assemblies are designed to allow the use of IVC cages and racks while providing video data. The video data enables unique identification of individual animals. The design includes, but is not limited to: 1) a sensor component that either replaces a cage lid or sits above the cage lid, designed to provide top-down view of mice and 2) replacement of existing food hoppers with custom food hoppers that cither a) provide a transparent lid and/or place the food compartment in the outer edges of the cage, allowing unobstructed camera views from the top.

Sensors on the dome assembly or within the cage environment that may work with the dome assembly or sensors on the dome assembly could include any or all from a group of: at least one or more sensors from a group of: optical sensors, motion sensors, pressure sensors, weight sensors, temperature sensors, humidity sensors, proximity sensors, chemical sensors, volume sensors, level sensors, audio sensors, odor sensors, heartbeat sensors, brainwave sensors, body mass sensors, color sensors, rotary sensors, light sensors, oscillation sensors, balance sensors, reflex or reaction sensors, waterflow sensors, force meter sensors, load sensors, electrical sensors, ammonia sensors, carbon dioxide sensors, and bite strength sensors, the sensors designed to monitor at least one or more of the environment and associated animals. As such, it should be understood that the dome assembly is designed to be a platform for sensors and is not confined to one or a few arrays of sensor types.

The dome assembly system composes minimally of four parts: 1) at least one camera providing top-down vision into an animal cage, 2) near infrared LED or other light sources providing illumination, 3) at least one transparent food hopper or existing cage lid to enable camera sight, 4) an outer encasing designed in a way to allow installation in and use with existing IVC racks. As there are multiple types of IVC racks on the market, the outer encasing, and the organization of components 1-4 take the form of multiple embodiments, each designed specifically for compatibility with at least one IVC rack system, as described in this disclosure below.

Additionally, some embodiments of the dome assembly may optionally contain: 1) A local computer, either single board or multi-board, attached either inside or immediately adjacent to the dome assembly; 2) at least one microphone (regular or ultrasonic); 3) at least one speaker or another sound emitting device (regular or ultrasonic); 4) a white or visible light emitting source; 5) at least one infrared light source; 6) at least one custom cage card holder; 7) at least one depth-of-field camera; 8) at least one dual camera; 9) at least one adjacent dedicated WIFI emitter for wireless data transfer; and 10) at least one on-board memory storage unit (such as an SD card, USB or hard drive) for local data storage.

To arrive at a design that fulfills the requirements above, it was necessary to overcome several problems present in one or all existing solutions. The problems and the inventive steps taken to solve them are as follows:

Full field of view: First, it was necessary to achieve a full field of view of the cage with the camera. While sides of existing IVC cages are transparent, side-placement of cameras cannot achieve this, since inevitably at least one area is occluded. Furthermore, side-placement of cameras causes occlusion of animals over each other as they cross paths and removes the possibility to score the total amount of animal movement. Bottom placement cannot achieve full fields of view either, since the floor is covered with bedding, reducing visibility. As a result, the disclosed invention solves this through top placement of one or more cameras.

Top placement of cameras: Achieving placement of cameras at the top of the cage, however, requires removal of intervening structures, such as cage tops and food hoppers that block views. Furthermore, to fit into a cage slot in an IVC rack, a moderate amount of height is available only (typically 4-7 inches), which prevents achieving full fields of view with standard wide-angle lenses. Embodiments of the disclosed invention solve these problems by placing at least one camera centrally above the cage, replacing the cage top and food hopper with alternatives that provide a transparent full field of view, and use a fish-eye-type lens of at least 160deg field of view to capture the whole cage, or multiple cameras with adjacent or overlapping fields of view.

Achieving field of view over food and water: Furthermore, to estimate the levels of food and water and eating and drinking-related behavior, visual observation of food and water levels was necessary. For this reason, embodiments of the disclosed invention are designed to include custom food hoppers with such dimensions to allow visual observation of food and water levels (if water bottles are used).

Maintaining consistent video quality night and day: Since mice and rats are nocturnal animals, active during the night, and sleeping during the day, it is particularly important to be able to provide video and other data recording during the night or other periods of darkness. This necessitates night vision. Embodiments of the disclosed invention solve these problems by implementing at least one camera that is sensitive in the near-infrared spectrum (NIR) and add a source of near-infrared light to the cage, placed in a way to provide consistent illumination across the whole cage, and may further be handled by cameras with ample sensitivity to the available light.

Unique identification of individual animals: To be able to provide robust health and data metrics for each animal, robust unique identification of each animal is necessary. To solve this problem, embodiments of the disclosed invention can include an animal identification device that places a tag on the ear or back skin of an animal, labeled with 1-3 numbers or letters that are legible through video (OldenTag™ system), coupled with a neural network trained to identify the locations of animals and identities of the tags.

Removing interference from white light: Furthermore, because downstream analysis can be sensitive to lighting conditions (for example, when a computer vision algorithm relies on the color of the background to separate animals from the background), it may be necessary to ensure consistent video color both day and night, in the presence or absence of natural light, and remove interference from white light. To solve this problem, embodiments of the disclosed invention can further add at least one optical filter that enables passage of near-infrared light only in the light path of the camera (in front or behind the fisheye lens). This optical filter could be any filter with a high-pass cut-off at or above 660 nm.

Moving the location of food: In all existing IVC cages, food is situated in the center of the cage. To achieve a full field of view top-down recording, the location of food in the food hopper must be placed to the side, away from the given cage's center. To solve this problem, embodiments of the disclosed invention can include custom food hoppers to store food at the side of the cage.

Providing a transparent top to a food hopper: Additionally, most existing IVC cages contain a non-transparent cage top, the food hopper, or both. To enable a top-down full field of view, it can be necessary to provide a transparent top. As a result, embodiments of the disclosed invention can include the transparent top to food hoppers (for cage types that do not have transparent top lids).

Achieving low-temperature functioning: Furthermore, the system must operate at sufficiently low power to not overheat or generate excessive heat. Embodiments of the disclosed invention can include systematically testing componentry and software to achieve optimal performance to obtain low-enough temperatures. For illustration, and in addition to other means, by removing unnecessary background operations in the onboard computer, by using a minimal number of near-infrared LED lights, acquiring video in grayscale and low resolution, and by performing pre-processing with an optimized algorithm, power use can be minimized. Additionally, in some embodiments, the dome assembly includes a heatsink exposed to the external air or rack surface to dissipate heat and further reduce operating temperature.

Achieving easy use and stable location of the camera. Cameras must be fixed within the rack while allowing the cage to slide in and out of the rack to allow easy usability. Affixing the camera to the top of the cage or to the cage itself forces it to be moved with the cage and prevents case of use. Embodiments of the disclosed invention solve this problem by designing the dome assembly encasing to be stably placed and locked against unwanted movement out of the rack through use of friction-fitting, clips, and/or reversible glue.

Wiring the unit: The invention must be wired in a way that does not interfere with the day-to-day operation of the rack and allows cleaning and decontamination. Embodiments of the disclosed invention solve this problem by affixing the wire to the side or back of the dome assembly and affixing the rack either horizontally or vertically away from the movement areas of the cages. Additionally, embodiments of the disclosed invention can include a voltage converter unit inside the dome assembly to power dome assembly internal systems using a single cable.

Shielding the unit from cleaning solutions: Additionally, the invention must be cleanable and sterilizable while maintaining high-quality sensor functioning. To solve this problem, embodiments of the disclosed invention can use materials (plastics, metals, or ceramics) and/or coatings that are resistant to common cleaning solutions (bleach, ethanol, isopropanol). Additionally, embodiments of the disclosed invention can use polymer gaskets around the wire entry point and watertight power connects to isolate electrical components from the cleaning solution.

Preventing soiling of the camera or transparent top: During the course of the day-to-day activities of rodents, airborne particulates (bedding feces and food dust) are generated and will gather on top of surfaces. This will reduce the transparency of the transparent cage top, preventing effective video recording. To solve this problem, embodiments of the disclosed invention can add a HEPA filter covering surfaces between the dome assembly and food hopper top.

Achieving an economic price point. Long-term recording and routine video-based rodent monitoring require a low price point to be economically feasible. Therefore, each component and/or the production method for each component was cost-optimized in design. Furthermore, embodiments of the disclosed invention can eliminate components present in other solutions, such as a) the use of custom racks to achieve in-home-cage video monitoring, and b) multiple side-placed cameras to achieve full field of view. These and other steps enabled substantial cost reduction.

To achieve the above, therefore, representative embodiments include the vertebrate monitoring system (as can be termed the dome) for the smart cage comprising at least one sensor array disposed on the smart cage over monitored vertebrate animals living within the smart cage, at least one sensor of the groups described above is disposed on the at least one sensor array designed to, in situ, monitor and collect data from the at least one or more of environmental conditions within the smart cage, vertebrate animal physiology, vertebrate animal activity, and vertebrate animal performance levels. The at least one video camera assembly is disposed to record top-down views of the smart cage interior and elements therein. The at least one light source is designed to illuminate the smart cage interior at intensity and color ranges adapted for the at least one video camera assembly, within detectable spectrum, therefore, of given at least one video camera assembly. The at least one audio sensor and audio recorder is designed to collect sounds originating from within the smart cage.

In some embodiments, a container is designed to contain the smart cage and vertebrate monitoring system, the container slotted inside an IVC rack. At least one transparent divider may be disposed between the vertebrate monitoring system and the smart cage interior. Sensors may be designed to detect at least one or more of electromagnetic waves, sound waves, temperature, humidity, ammonia levels, and carbon dioxide levels within the smart cage. At least one mechanism for generating stimuli may be disposed within the smart cage, wherein the stimuli include at least one or more of sound, light, and heat. The at least one video camera assembly may be operably coupled to one or more machine learning algorithms capable of identifying behaviors and health conditions based on the animal movements and interactions within the smart cage.

Machine learning algorithms may include at least one Convolutional Neural Network (CNN) designed to identify and track specific body parts or features of animals within video footage. Machine learning algorithms may include at least one supervised learning algorithm designed to classify animal behaviors based on features extracted from video data. Machine learning algorithms may include graphical tracking of animal movement within smart cages. Machine learning algorithms may include classification and clustering algorithms designed to track multiple animals within smart cages.

A variable adapter mechanism may allow for the attachment of monitoring equipment to various types of animal cages. A centralized data collection hub may be present for aggregating data from multiple cages. A software platform with a user interface may be present on site or on an operably connected computerized device for analyzing aggregated data and providing insights into the health and well-being of the animals across different cages and racks. The variable adapter mechanism is designed to accommodate cages of different sizes and shapes.

One representative method for using the vertebrate monitoring system for a smart cage comprises monitoring at least one vertebrate animal by way of at least one sensor array disposed on the smart cage and over the at least one monitored vertebrate animal. This method includes collecting, in situ, data from at least one or more of vertebrate animal physiology, the smart cage environment, and the one or more vertebrate animal's activities and performance levels within the smart cage environment. This method includes recording by way of at least one video camera assembly top-down views of the smart cage interior and elements therein. This method includes illuminating by way of at least one light source the smart cage interior at an intensity adapted for at least one camera assembly. This method can include recording by way of at least one audio sensor and audio recorder sounds originating from within the smart cage.

A general object of the invention is to provide a system that enables the collection of phenomics data in-home-cage animal monitoring and health tracking in IVC racks that is easy to use, energy efficient, and avoids stressing the animals.

A secondary object of the invention is to provide modularity so the sensor arrays can be changed without changing the entire system.

These and other objects, features, and advantages of the present invention will become readily apparent upon a review of the following detailed description of the invention, in view of the drawings and appended claims.

The inventive concept, including a corresponding method for using the disclosed system, now will be described more fully hereinafter with reference to the accompanying drawings, which are intended to be read in conjunction with both this summary, the detailed description, and any preferred and/or particular embodiments specifically discussed or otherwise disclosed. This inventive concept may, however, be embodied in many different forms and should not be construed as limited to the embodiments set forth herein; rather, these embodiments are provided by way of illustration only and so that this disclosure will be thorough, complete, and will fully convey the full scope of the inventive concept to those skilled in the art.

### BRIEF DESCRIPTION OF THE DRAWINGS

The nature and mode of the operation of the present invention will now be more fully described in the following detailed description of the invention taken with the accompanying drawing figures, in which:

FIG. 1A: Dome assembly perspective view;

FIG. 1B: Dome assembly side view;

FIG. 2A: Dome assembly bottom view;

FIG. 2B: Dome assembly perspective top view;

FIG. 2C: Dome assembly perspective bottom view;

FIG. 3A: Smart cage side view;

FIG. 3B: Smart cage front view;

FIG. 3C: Smart cage side view open;

FIG. 4: Smart cage profile view open;

FIG. 5: Smart cage IVC rack assembly and graphic monitor;

FIGS. 6A-6B: Representative smart cage method;

FIG. 7: Representative sensor array; and

FIG. 8: Representative variable adapter mechanisms.

### DETAILED DESCRIPTION OF THE INVENTION

Following are detailed descriptions of various related concepts related to, and embodiments of, methods and apparatus according to the present disclosure. It should, however, be understood that this disclosure is not limited to the particular methodology, materials, and modifications described and, as such, may, of course, vary. It is also understood that the terminology used herein is for the purpose of describing particular aspects only and is not intended to limit the scope of the claims.

Furthermore, it should be appreciated that drawings are representative to illustrate the inventive concepts herein and may not be to scale. Also, like drawing numbers on different drawing views identify identical, or functionally similar, structural elements where there could appear some variations on exactness where exactness is not material to the inventive concept herein. It is to be understood that the claims are not limited to the disclosed aspects.

Unless defined otherwise, all technical and scientific terms used herein have the same meaning as commonly understood to one of ordinary skill in the art to which this disclosure pertains. It should be understood that any methods, devices, or materials similar or equivalent to those described herein can be used in the practice or testing of the example embodiments.

It should be appreciated that the term “substantially” is synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims. It should be appreciated that the term “proximate” is synonymous with terms such as “nearby,” “close,” “adjacent,” “neighboring,” “immediate,” “adjoining,” etc., and such terms may be used interchangeably as appearing in the specification and claims. It should be appreciated that the term “distal” and comparably related terms denoting further-away portions of an item are antonymous to proximal portions of the co-described item as those portions of items may be termed. The term “approximately” is intended to mean values within ten percent of the specified value.

It should be understood that the use of “or” in the present application is with respect to a “non-exclusive” arrangement unless stated otherwise. For example, when saying that “item x is A or B,” it is understood that this can mean one of the following: (1) item x is only one or the other of A and B; (2) item x is both A and B. Alternately stated, the word “or” is not used to define an “exclusive or” arrangement. For example, an “exclusive or” arrangement for the statement “item x is A or B” would require that x can be only one of A and B. Furthermore, as used herein, when referring to a set or group of items, for illustration (A, B, C) the term “at least one or more . . . and . . . ” such as in “at least one or more of A, B, and C” is intended to include any to all of the denoted set or group of items, i.e. it could include just one item from the set or group, it could include all of the items from the set or group, and it could include any other combination of the set or group of items that is greater than one item and less than all of the items, the illustrated example having three items meaning there are up to seven non-ordered combinations A, B, C, AB, AC, BC, ABC. Other numbers of items would have maximum combination possibilities calculated accordingly.

Moreover, as used herein, the phrases “comprises at least one of” and “comprising at least one of” in combination with a system or element is intended to mean that the system or element includes one or more of the elements listed after the phrase. For example, a device comprising at least one of: a first element; a second element; and, a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element. A similar interpretation is intended when the phrase “used in at least one of:” is used herein.

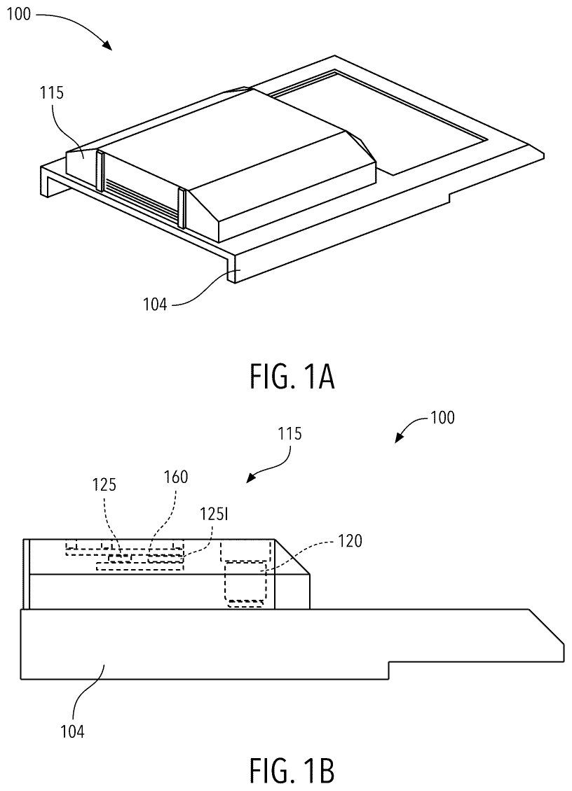

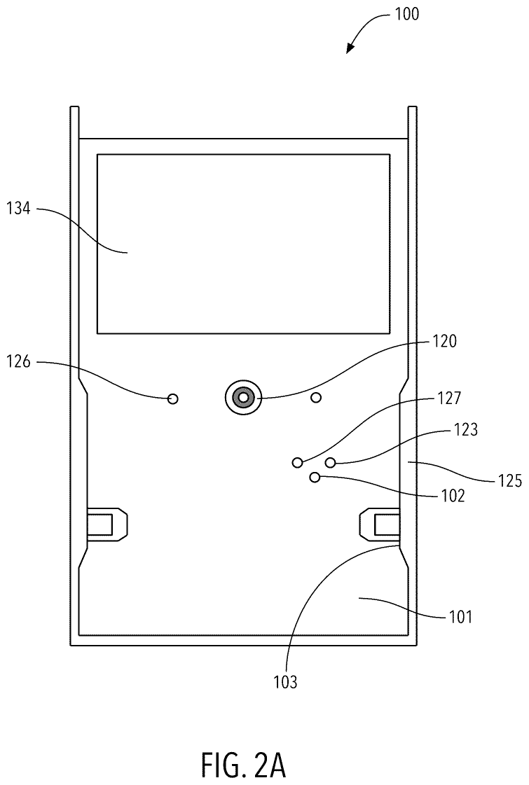

Disclosed and illustrated in FIGS. 1-5, is a vertebrate monitoring system for an animal cage having at least one sensor array 115 disposed on the animal cage, with animal cage hereinafter referred to as smart cage 110 and over the monitored vertebrate animals where it has a view of the animal cage floor, termed container floor 131. The illustrations are representative and do not limit the invention to the designs shown or the proportions presented.

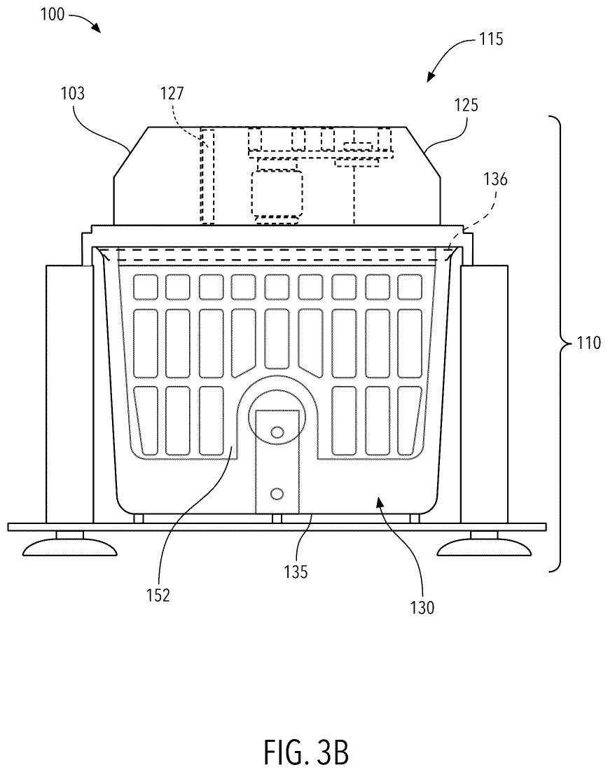

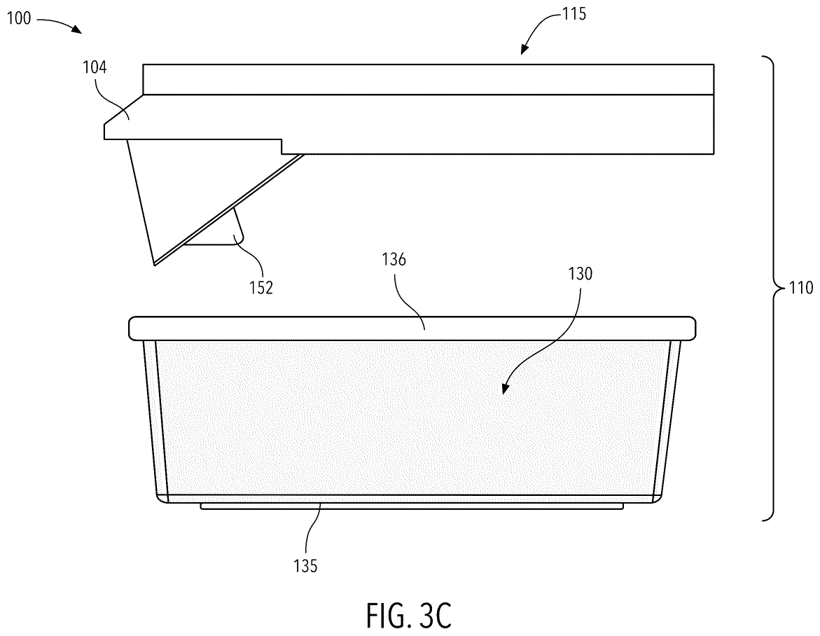

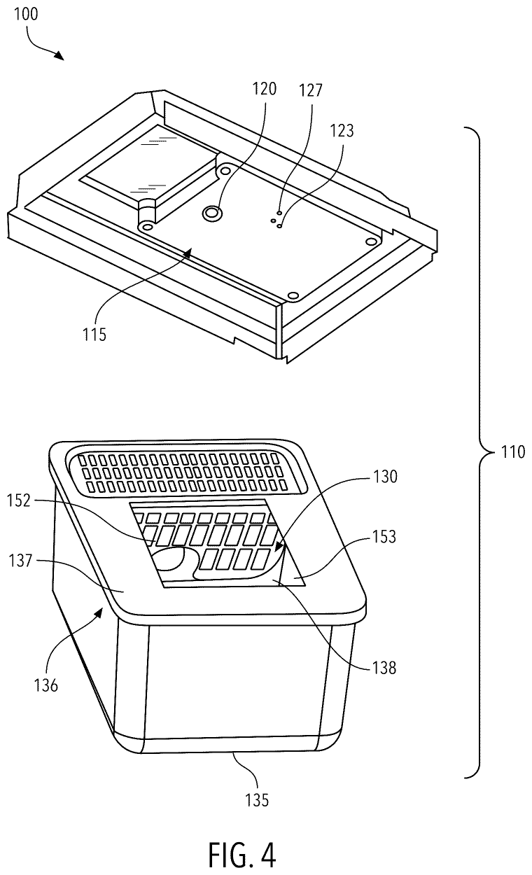

FIGS. 1A and 1B illustrate dome assembly 100 on which is mounted sensor array 115. Dome assembly 100 has dome cover 104 on which is sensor array 115, dome 104 designed to be a specified size and configuration, depending on the dimensions of the body on which it will rest, such as, as will be shown in FIG. 3A, IVC rack vertical frame members 149 between which is container 135. FIG. 1B further illustrates representative camera assembly 120 and LED light source 125, which may be or may include near-infrared LED light source 125I. Single-board computer 160 is also illustrated.

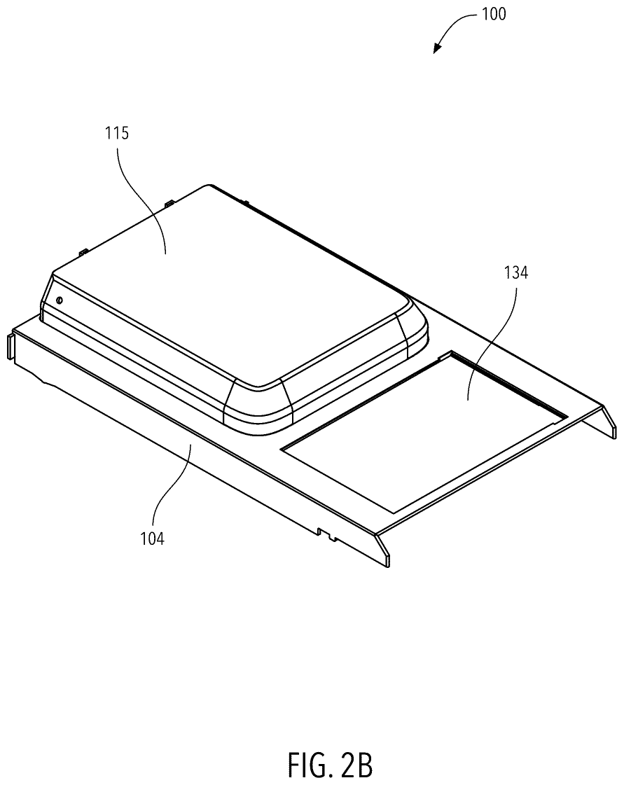

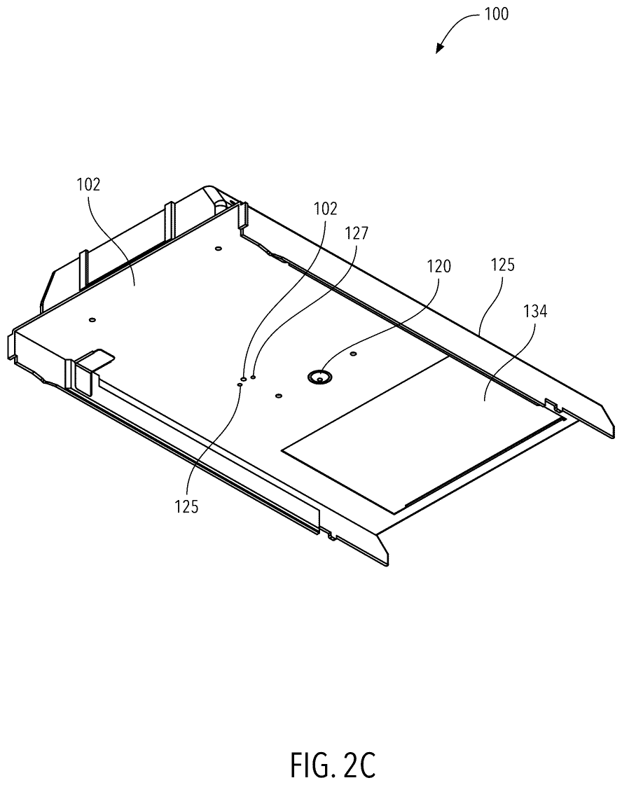

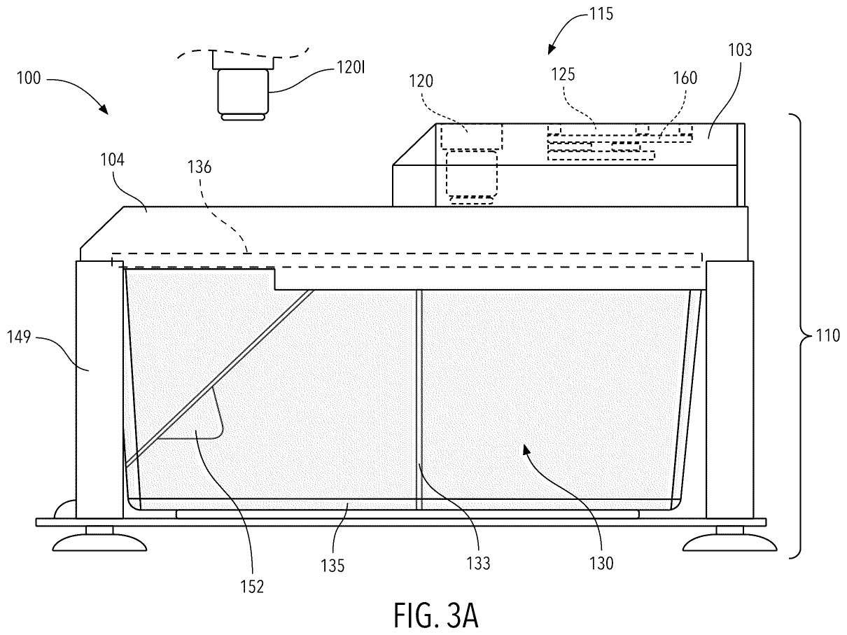

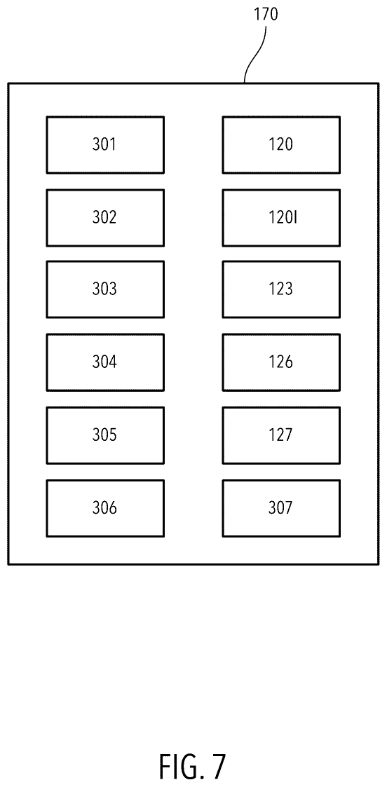

FIGS. 2A, 2B, and 2C illustrate underside of representative dome assembly 101, wherein there may be plurality of hole members 102 through which can operate one or more of camera assembly 120, audio sensor 123, audio recorder 127, and speaker 126. Further included in the representative embodiment, as illustrated in FIG. 7, sensors 170 are from a group including at least one of the following: sensor for electromagnetic waves 301, sensor for sound waves 302, sensor for temperature 303, sensor for humidity 304, sensor for ammonia levels 305, sensor for carbon dioxide levels 306, and sensor for thermal imaging 307, within smart cage 110, as well as aforementioned camera assembly 120, infrared camera assembly 126, audio sensor 123, audio recorder 127, and speaker 126. Sensors 170 as a term here corresponds to sensor array 115 in which or on which would be held individual sensors 170 that could, as required, detect the above wherein many types and capabilities of sensors 170 may be used from different sources where illustrations of the invention are representative smart cage 110. Although a sensor array 117 may include many sensors 170, embodiments may also include few sensors 170, for example, minimum dome 100 designs may only attach cameras 120/120I and LED light source 125 to IVC rack vertical frame members 149 a single compute unit 160.

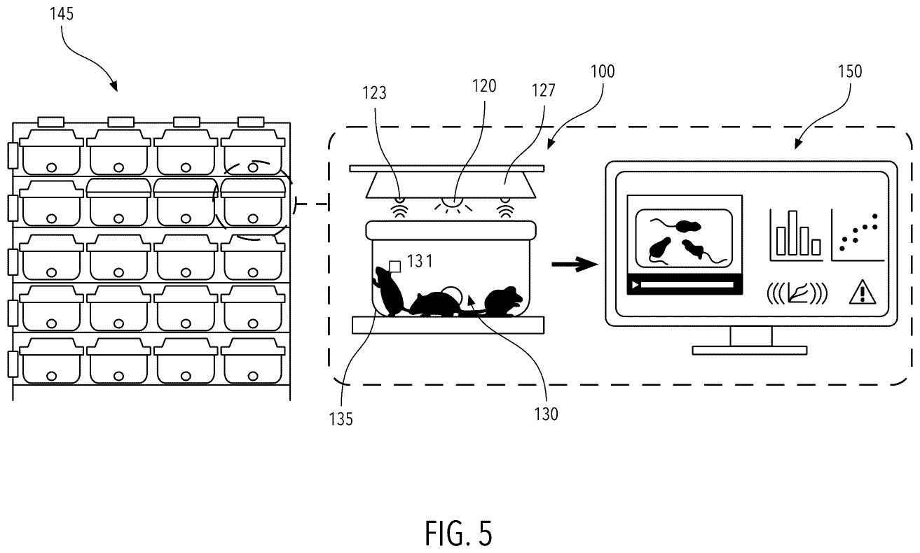

Sensors 170 as a term here corresponds with sensor array 115 in which or on which would be held individual sensors 170 that could, as required, detect the above wherein many types and capabilities of sensors may be used from different sources where illustrations of the invention are representative. LED light source 125 in this embodiment is placed on top interior sides of dome assembly 103, top interior sides of dome assembly 103 which may be operably viewable when dome assembly 100 has transparency. Included is opening 134, which may be completely open or may, as shown in FIG. 4, include transparent top 153.

FIGS. 3A, 3B, and 3C respectively illustrate a side closed, front, and side open view of complete smart cage 110 embodiments wherein added elements are container 135 forming smart cage interior 130, to which there can be further transparent dividers 133, shown in FIG. 3A. Included is at least one video camera assembly 120, which may include near infrared camera 120I. Dome 100, in this embodiment, rests atop IVC rack vertical frame members 149 between which is container 135, but could also rest atop another frame design or directly onto container 135 by way of dome cover 104 resting on container rim 136. Connected sensor array 115 is part of dome 100, the combination which forms smart cage 110. Smart cage interior 130 may have many items from which to create a habitat for mice and other animals being food hopper 152, which can further be used as a mechanism for generating stimulus or reward. LED light source 125 in this embodiment, illuminating within detectable spectrum, therefore, of given at least one video camera assembly 120, is placed on top interior sides of dome assembly 103. Single-board computer 160 is also illustrated.

FIG. 4 illustrates a profile view of open smart cage 110, further illustrating that container 135 may have container top 137 adapted to rest on container rim 136 through which may be cut one or more container top openings 138. Further, this representative top opening 138 is designed to have transparent top 153 as would be useful to keep animals apart from sensors 170 but allow sensors 170, such as video camera assembly 120, which may include near infrared camera 120I, to capture images therethrough. Representative food hopper 152 is also shown.

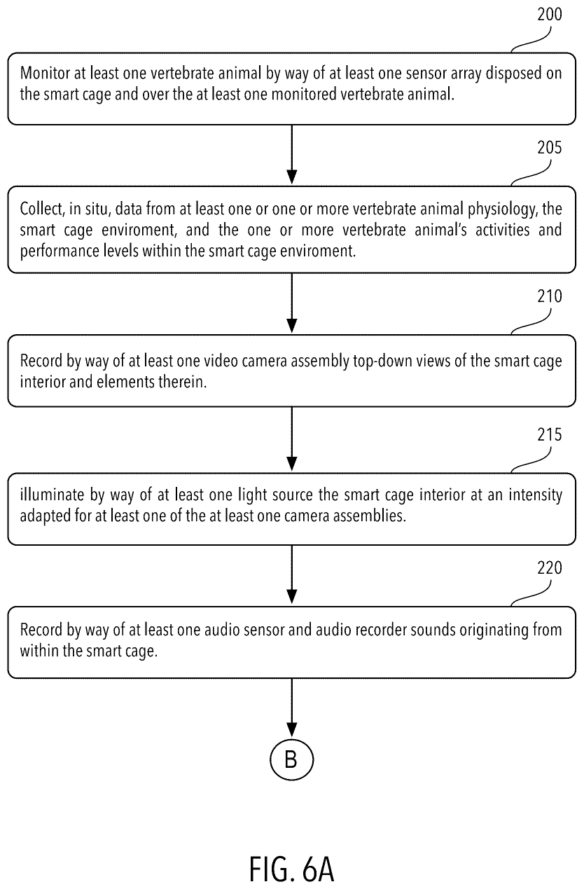

FIG. 5 illustrates a broader system of smart cages 110 as stored in IVC rack 145, which may accommodate many smart cages 110. Mice are illustrated with example of tag 131. Further, one or more smart cages may be monitored by a graphical user interface such as graphical user interface 150.

At least one or more sensors 170 are disposed on or in the at least one sensor array 115 designed to, in situ, monitor and collect data from at least one or more of vertebrate animal physiology, smart cage 110 environment created in smart cage interior 130, and the one or more vertebrate animal's activities and performance levels within smart cage 110 environment. Defining in situ, operations can be undertaken without removing or handling the smart cages 110 or animals. Sensors 170 include sensors 170 from a group designed to detect at least one of the following: electromagnetic waves, sound waves, temperature, humidity, ammonia levels, carbon dioxide levels, thermal images, within smart cage 110, as well as elements detected by aforementioned camera assembly 120, infrared camera assembly 126, audio sensor 123, audio recorder 127, and speaker 126 and may include any combination of sensors suitable for given experiments that may fit in dome 100 or associated sensor array 115. Embodiments are not limited to these sensors 170.

At least one video camera assembly 120 is disposed to record top-down views of smart cage interior 130 along with elements and animals therein. At least one light source 125, as illustrated in FIG. 3A, is designed to illuminate smart cage interior 130 at an intensity designed for at least one of at least one video camera assembly 120, which may include near infrared camera 120I, to capture images of suitable detail. At least one audio sensor 123 and audio recorder 127 are designed to collect sounds originating from within smart cage 110.

In some embodiments of the vertebrate monitoring system for smart cage 110, a secondary container, not shown, is designed to contain the animal cage and vertebrate monitoring system inside IVC rack 145. In some embodiments of the vertebrate monitoring system for a smart cage 110, transparent divider 133 is included as a part of the vertebrate monitoring system and smart cage 110. In some embodiments of the vertebrate monitoring system for smart cage 110, sensors 170 comprising sensor array 115 are from one or more groups designed to detect at least one of the following: electromagnetic waves, sound waves, temperature, humidity, ammonia levels, and carbon dioxide levels within smart cage 110. In some embodiments of the vertebrate monitoring system for smart cage 110 at least one mechanism for generating stimuli is disposed within smart cage 110, wherein the stimuli include at least one of: sound, light, and heat and which may include illustrated light source 120 and microphone 126. In some embodiments of the vertebrate monitoring system for smart cage 110, at least one video camera assembly 120 is equipped with machine learning algorithms capable of identifying specific behaviors or health conditions based on the animals' movements and interactions within smart cage 110.

Several representative types of machine learning algorithms can be useful for tracking animal movement, physiology, and performance within a laboratory cage. These algorithms can include but are not limited to: object detection and tracking by way of Convolutional Neural Networks (CNNs) trained to identify and track specific body parts or features of animals within video footage, allowing for precise measurement of movement and behavior; pose estimation algorithms, such as OpenPose or DeepLabCut, used to estimate the skeletal pose or key points of animals from video data, tracking the movement of specific body parts or joints over time, providing detailed information about posture, gait, and activity patterns; supervised learning algorithms, such as Support Vector Machines (SVMs) or Random Forests, trained to classify animal behaviors based on features extracted from video or sensor data, categorizing behaviors such as grooming, exploration, feeding, or social interactions, enabling researchers to analyze complex behavioral sequences; analysis of physiological data collected from sensors or biotelemetry devices such as time series analysis, anomaly detection, and pattern recognition can help identify physiological states, detect stress responses, or predict health outcomes based on physiological parameters; regression algorithms for performance prediction, such as Linear Regression or Gradient Boosting, used to predict performance metrics such as running speed, endurance, or task performance based on behavioral and physiological data, these algorithms helping researchers understand the factors influencing animal performance and identify interventions to improve outcomes.

Machine learning algorithms in representative embodiments may further utilize graphical tracking of animal movement within smart cages 110, typically involving representing smart cage 110 environment and the animals as a graph or associated matrix, where nodes represent locations or objects of interest (e.g., animals, landmarks, or tracking points), and edges represent the connections or relationships between them (e.g., proximity or adjacency). Such may include, but are not limited to: Graph Neural Networks (GNNs) neural networks designed to operate on graph-structured data used to model the interactions between animals and their environment, learn spatial dependencies, and predict animal trajectories or behaviors within smart cage 110; Graph-based Clustering algorithms such as Spectral Clustering or Louvain Modularity applied to the graph representation of animal movement data to identify spatial clusters or communities of animals within smart cage 110, helping to characterize social dynamics, group behaviors, or spatial preferences of animals; Graph-based Tracking and Localization tracking algorithms using the graph structure to model the movement of animals as a sequence of graph transformations, the algorithms tracking individual animals or groups of animals over time, inferring their locations within smart cage 110, and estimating movement trajectories based on observed interactions and spatial constraints; Graph-based Anomaly Detection applied to the graph representation of animal movement data, identifying unusual or unexpected patterns in behavior, such as outliers or deviations from typical movement patterns; helping detect abnormal behaviors, stress responses, or health issues in laboratory animals; and Graph-based Reinforcement Learning (RL) designed to operate on graphs to learn optimal control policies for tracking animal movement within smart cage 110, representing smart cage 110 environment as a graph and defining appropriate reward functions, predicting how animals navigate obstacles, explore the environment efficiently, and perform tasks or experiments.

Machine learning algorithms in representative embodiments can further be used for tracking multiple and individual animal physiology and performance levels within a laboratory cage, particularly when dealing with datasets that involve groups of vertebrate animals and their interactions. Some useful algorithms in this context include: Classification and Clustering algorithms, such as k-means clustering or hierarchical clustering, applied to physiological and performance data collected from multiple animals to identify patterns, similarities, and differences among groups of animals, helping to classify animals based on physiological parameters or performance metrics and group them according to shared characteristics; Regression and Prediction regression algorithms, such as set regression or set prediction models, used to predict physiological states or performance outcomes for groups of animals based on their collective characteristics, the algorithms taking into account the interdependencies and interactions between individual animals within a group and providing aggregate predictions for the group as a whole; and Anomaly Detection algorithms designed to identify unusual or unexpected patterns in physiological or performance data that deviate from the norm for a group of animals, comparing individual animal data to the collective behavior of the group to detect outliers, anomalies, or deviations indicative of health issues, stress responses, or abnormal behaviors.

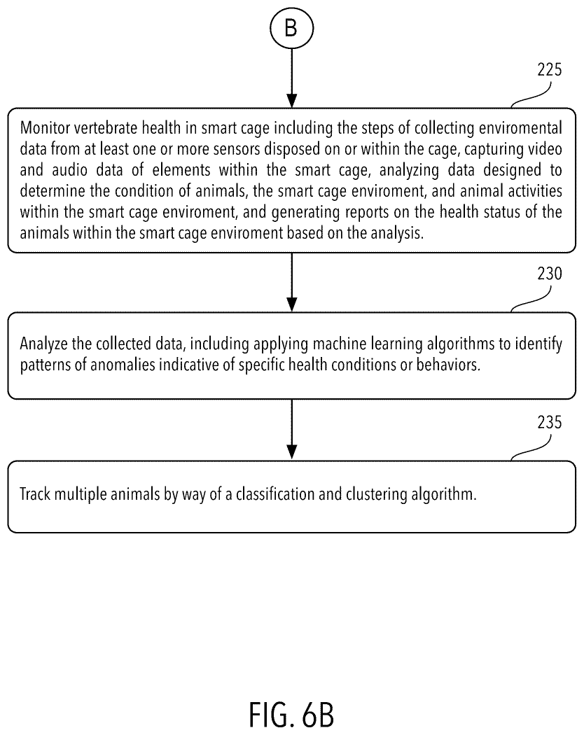

FIGS. 6A and 6B illustrate a vertebrate monitoring method for smart cage 110 including the step of 200 monitoring at least one vertebrate animal by way of at least one sensor array 115 disposed on smart cage 110 and over the at least one monitored vertebrate animal. The method further includes the step of 205, collecting, in situ, data from at least one or more of vertebrate animal physiology, smart cage 110 environment, and the one or more vertebrate animal's activities and performance levels within smart cage 110 environment. The method further includes the step of 210, recording by way of at least one video camera assembly top-down views of smart cage 110 interior and elements therein. The method further includes the step of 215, illuminating by way of at least one light source 125 smart cage 110 interior at an intensity designed for at least one of the at least one camera assemblies 120. The method further includes the step of 220, recording by way of at least one audio sensor 123 and audio recorder 127 sounds originating from within smart cage 110.

Further disclosed is a method for monitoring vertebrate health in smart cage 110 including the step of 225, collecting environmental data from at least one or more sensors 170 disposed on or within smart cage 110, capturing video and audio data of elements within smart cage 110, analyzing data designed to determine the condition of animals, smart cage 110 environment, and animal activities within smart cage 110 environment, and generating reports on the health status of the animals within smart cage 110 environment based on the analysis. The method may further include the step of 230, analyzing the collected data, including applying machine learning algorithms to identify patterns or anomalies indicative of specific health conditions or behaviors. The method may further include the step of 235, tracking multiple animals by way of a classification and clustering algorithm.

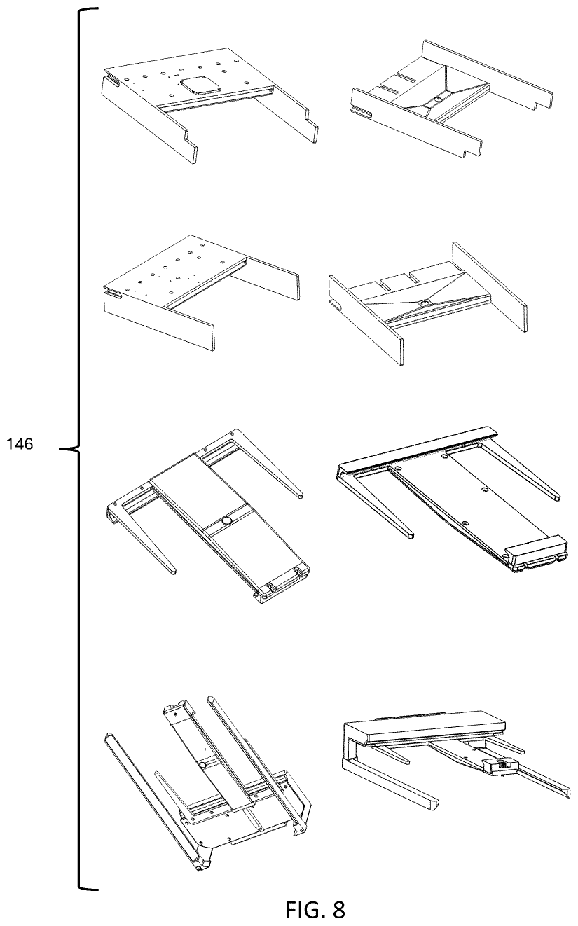

Further disclosed is vertebrate monitoring system for smart cage 110 including, as illustrated in FIG. 8, a variable adapter mechanism 146 designed to attach monitoring equipment to various types of smart cages 110. Furthermore, in another embodiment, the electronics compartment encompassing at least the compute unit may be modularly attached to the encasing via a clip-based adapter system. In this embodiment, the system consists of two parts. The first part includes a module containing the compute unit, electronics, optionally camera, 120/120I optionally LED 125, and optionally microphone/audio sensor 123, and the second part is rack 145 or variable adapter mechanism 146. The electronics module connects to the adapter using snap-fit Connectors, slide rails, hinged assemblies, or one or more of the list below. The cage adapter contains at least the part required to operationally couple the system to a rack 145, and may include LEDs 125, power cord, and other electronics components. Electronic modules may be coupled to the adapter using a USB port, power cable ports or other electrical connects.

In a further embodiment, one electronics compartment may connect to multiple adapters placing a camera 120/120I, LEDs 125, microphones 123 or other sensors 170 above each smart cage 110 in rack 145. In this embodiment, the encasings or sensor arrays 117 encompassing LEDs 125, cameras 120/120I, and optionally other sensors 170 may be placed above smart cages 110 individually or as operationally coupled into rows or columns covering multiple cages 110. Each sensor array 117 may then connect to one or more computer units 160. All rows or columns or individual sensor arrays 117 on rack 145 may connect to a single computer unit 160.

Included may be a centralized data collection hub for aggregating data from multiple smart cages 110. Included may be a software program for analyzing aggregated data about the health and well-being of the animals across different smart cages 110 and racks 145. Included may be a mechanism designed to accommodate cages of different sizes and shapes.

FIGS. 1-6B further illustrate that dome assembly 100 has at least one sensor 170, such as video camera assembly 120 located inside IVC rack 145 and provides at least one video feed that is analyzed and presented to the user through at least one graphical user interface 150. Depending on the type of IVC rack 145 system, dome assemblies 100 have design modifications to allow compatibility as described below. The following is a representative illustration of dome assemblies 100. Embodiments may, as needed, use multiples of singularly listed components and may use single components where multiple members of that component are listed. IVC rack 145 system may hold multiple smart cages 110 each with dome assemblies 100 and a given animal may further have access to more than one smart cage 110. Smart cage 110 is compatible with existing IVC racks, as illustrated in FIG. 5, which depicts multiple smart cages 110 housed within an IVC rack 145. The minimal configuration of the DOME assembly, shown in FIGS. 1A and 2A, includes at least one camera 120 providing top-down vision, near-infrared LED light sources 125I, a food hopper 152, cage lid 153, smart cage 110 designed for installation in given IVC racks 145. The system can track individual animals in group-housed settings (in conjunction with OldenTag™ or other tag 131 systems) and return data on health metrics and smart cage 110 conditions for vertebrate animals.

FIG. 7 illustrates a representative group of sensors 170, for example camera assembly 120, infrared camera assembly 120I, audio sensor 123, audio recorder 127, and speaker 126, and sensors for detecting electromagnetic waves 301, sound waves 302, temperature 303, humidity 304, ammonia levels 305, carbon dioxide levels 306, and thermal imaging 307 within smart cage 110. —along with light source 125 that may work in concert with these other sensors 170. Sensors 170 as a term here corresponds to sensor array 115 in which or on which would be held individual sensors 170 that could, as required, detect the above wherein many types and capabilities of sensors 170 may be used from different sources where illustrations of the invention are representative.

FIG. 8 illustrates various dome 100 variable adapter mechanisms 146, of which given design requirements are only that it can retain the sensors 170 and placement thereof as required for given experiments. Such is associated with sensor array 117, which may also include other separately fixed or placed members of sensors 170.

Embodiments of Allentown-type dome assemblies. To achieve continuous, long-term video-based multi-animal tracking and monitoring in Allentown-type IVC racks 145, the disclosed invention includes dome assemblies 100 that further serve as a cage lid and food hopper 152 designed to work with dome assemblies 100 as a part of animal and environment monitoring. The representative disclosed food hopper 152 contains a food and water bottle basket placed in the vicinity of the back wall, sloping up at an angle to enable a full field of view. To prevent soiling of transparent lid 153 and maintain pristine air, a HEPA filter, not shown, may cover food basket area of food hopper 152. Dome assembly 100 is inserted into locations where otherwise, typically traditional cage lids would be placed and affixed in that location by at least one or more of friction fitting, clips, and reversible glue. Dome assembly 100 may contain at least one near-infrared camera 120I centrally placed with a top-down view, a typically single-board computer 160, a power source, and one or more near-infrared LED light source 125I. The near-infrared LED light source 125I is typically placed on the side to improve the uniformity of illumination and reduce reflection artifacts. Video camera assembly 120 typically features a camera with a lens that has a 160° or higher field of view—sometimes referred to as a fisheye lens—sensitive to near-infrared light and contains a near-infrared high-pass filter. Power sources in preferred embodiments include a 12V power cable, but other cables may be used, particularly as may be suitable for the given power grid.

Embodiments of Innovive-type cages. To achieve continuous long-term video-based multi-animal tracking and monitoring in Innovive-type IVC racks 145, representative embodiments may include dome assemblies 100 designed to fit above the top cage lid 153 by term container top 137 and food hopper 152 designed to work with dome assembly 100 to replace traditional food hoppers 152, but still, nonetheless, food hopper 152. Food hopper 152, in these embodiments, may contain a food basket placed in the vicinity of either the back or front wall, sloping up at an angle to enable a full field of view. Dome assembly 100 is inserted into a narrow space between the cage lid container top 137 and stably affixed in location by friction fitting, clips, and/or reversible glue. Dome assembly 100 contains near-infrared camera 120I, centrally placed with a top-down view, single-board computer 160, a power source, and near-infrared LED light source 125I. Near-infrared LED light source 125I is placed on top interior sides of dome assembly 103 to improve the uniformity of illumination and reduce reflection artefacts. Near-infrared video camera assembly 120I typically includes a lens with a 160deg or higher field of view, sensitive to near-infrared light, and containing a near-infrared high-pass filter. Alternatively, several cameras may constitute near-infrared camera assemblies 120I and may be used to ensure 160deg coverage.

In additional embodiments, dome assemblies 100 may include computer 160 locally, either single-board or multi-board, attached either inside or immediately adjacent to dome assembly 100, 2) audio sensor 123, which may be termed microphone (regular or ultrasonic), 3) Speaker 126 or another sound emitting device (regular or ultrasonic), 4) white or visible light emitting source 125, 5) infrared light source 125I, 6) and further may include custom cage card holder, 7) depth-of-field camera, 8) dual cameras, 9) adjacent dedicated WIFI emitter for wireless data transfer, and 10) on-board memory storage unit (such as an SD card, USB or hard drive) for local data storage. The type and brand of such elements in this and preceding paragraphs are interchangeable in as much as the researcher can use the base variations of cameras 120, audio sensors 123, speakers 126, and the like that suit the experiment being undertaken and this disclosure is not limited to specific accessories, such as lens types, needed to conduct an experiment that can be conducted using the invention as disclosed.

Furthermore, in additional embodiments, the encasing of dome assemblies 100 may take various shapes, particularly to suit shapes of given containers 135.

The following patents are incorporated by reference in their entireties: U.S. Pat. Nos. 11,330,804, 11,109,801, 10,905,094, 10,420,503, 10,278,361, 9,516,857, 8,739,737, 8,161,910, 10,575,495, 10,973,202, 11,129,358, 5,000,120, 6,308,660, 5,307,757, 4,699,088, 5,513,596, 5,148,766, 5,894,816, 6,357,393, 10,634,548, US100, 64392, U.S. Pat. Nos. 10,709,110, 9,986,716, 10,398,316, US20230046736, US20190183097, US20180007862, US20180103609, US20170000081, US2019018309, US20190037800, US20190167178, US20170105385, US20170108369, US20190183089, US20180092605, CN 217694864, CN114586689, CN216627035, CN110583501, CN108812363, CN107278929, and EP2034815.

The following literature references are incorporated by reference in their entireties:
Singh S, Bermudez-Contreras E, Nazari M, Sutherland R J, Mohajerani M H Low-cost solution for rodent home-cage behaviour monitoring. PLoS ONE 14(8): e0220751 (2019). Chen, Z. et al. Automated, high-dimensional evaluation of physiological aging and resilience in outbred mice. Elife 11, (2022).
Kalliokoski, O. et al. Mice Do Not Habituate to Metabolism Cage Housing—A Three Week Study of Male BALB/c Mice. PLoS One 8, e58460 (2013).
Bellantuono, I. et al. A toolbox for the longitudinal assessment of healthspan in aging mice. Nat Protoc 15, 540-574 (2020).
Brown, S. D. M. et al. High-throughput mouse phenomics for characterizing mammalian gene function. Nat. Rev. Genet. 19, 357-370 (2018).
Whitehead, J. C. et al. A clinical frailty index in aging mice: Comparisons with frailty index data in humans. Journals Gerontol. —Ser. A Biol. Sci. Med. Sci. 69, 621-632 (2014).
Ackert-Bicknell, C. L. et al. Aging Research Using Mouse Models. Curr. Protoc. Mouse Biol. 5, 95-133 (2015).
Justice, J. N. et al. Battery of behavioral tests in mice that models age-associated changes in human motor function. AGE 2013 362 36, 583-595 (2013).
Deacon, R. M. J. Measuring the Strength of Mice. JoVE (Journal Vis. Exp. e2610 (2013) doi:10.3791/2610.
Smith, J. P., Hicks, P. S., Ortiz, L. R., Martinez, M. J. & Mandler, R. N. Quantitative measurement of muscle strength in the mouse. J. Neurosci. Methods 62, 15-19 (1995).
Wimmer, M. E., Hernandez, P. J., Blackwell, J. & Abel, T. Aging impairs hippocampus-dependent long-term memory for object location in mice. Neurobiol. Aging 33, 2220-2224 (2012).
Wimmer, M. E. et al. Aging in Mice Reduces the Ability to Sustain Sleep/Wake States. PLoS One 8, e81880 (2013).
Deacon, R. M. J. Assessing nest building in mice. Nat. Protoc. 2006 13 1, 1117-1119 (2006).
Storchi, R. et al. Measuring vision using innate behaviours in mice with intact and impaired retina function. Sci. Reports 2019 91 9, 1-16 (2019).
Jussi Jero, D. E. C. A. K. L. The Use of Preyer's Reflex in Evaluation of Hearing in Mice. http://dx.doi.org/10.1080/00016480118142 121, 585-589 (2009).
Ounpraseuth, S. et al. A Method to Quantify Mouse Coat-Color Proportions. PLoS One 4, e5414 (2009).
Bewley, A., Ge, Z., Ott, L., Ramos, F., & Upcroft, B. (2016). Simple online and realtime tracking. In 2016 IEEE International Conference on Image Processing (ICIP) (pp. 3464-3468). IEEE.
Wojke, N., Bewley, A., & Paulus, D. (2017). Simple online and realtime tracking with a deep association metric. In 2017 IEEE International Conference on Image Processing (ICIP) (pp. 3645-3649). IEEE.
Bergmann, P., Meinhardt, T., & Leal-Taixé, L. (2019). Tracking without bells and whistles. In Proceedings of the IEEE/CVF International Conference on Computer Vision (pp. 941-951).
Milan, A., Schindler, K., & Roth, S. (2016). Challenges of ground truth evaluation of multi-target tracking. In 2016 IEEE Conference on Computer Vision and Pattern Recognition Workshops (CVPRW) (pp. 735-742). IEEE.
Leal-Taixé, L., Milan, A., Reid, I., Roth, S., & Schindler, K. (2017). Tracking the trackers: An analysis of the state of the art in multiple object tracking. arXiv preprint arXiv:1705.02750.
Bewley, A., Ge, Z., Ott, L., Ramos, F., & Upcroft, B. (2016). Simple online and realtime tracking. In 2016 IEEE International Conference on Image Processing (ICIP) (pp. 3464-3468). IEEE.
Luo, W., Xing, J., & Milan, A. (2014). Multiple object tracking: A literature review. arXiv preprint arXiv:1409.7618.
Kim, C., Li, F., Ciptadi, A., & Rehg, J. M. (2015). Multiple hypothesis tracking revisited. In Proceedings of the IEEE International Conference on Computer Vision (pp. 4696-4704).
Voigtlaender, P., Krause, M., Osep, A., Luiten, J., Sekar, B. B. G., Geiger, A., & Leibe, B. (2019). Mots: Multi-object tracking and segmentation. In Proceedings of the IEEE/CVF Conference on Computer Vision and Pattern Recognition (pp. 7942-7951).
Bergmann, P., Meinhardt, T., & Leal-Taixé, L. (2019). Tracking without bells and whistles. In Proceedings of the IEEE/CVF International Conference on Computer Vision (pp. 941-951).
Bochinski, E., Senst, T., & Sikora, T. (2020). Understanding the limitations of CNN-based multi-object tracking. In Proceedings of the 28th ACM International Conference on Multimedia (pp. 3152-3160).
Wang, Q., Zhou, L., Zhang, Z., & Qi, H. (2020). Deep online learning for multi-object tracking and segmentation. In Proceedings of the IEEE/CVF Conference on Computer Vision and Pattern Recognition Workshops (pp. 886-887).
Zhang, H., & Patel, V. M. (2020). Joint multi-object tracking and segmentation with detection-refinement. In Proceedings of the European Conference on Computer Vision (ECCV) Workshops (pp. 332-345).

While the inventive concept has been described above in terms of specific embodiments, it is to be understood that the inventive concept is not limited to these disclosed embodiments. Upon reading the teachings of this disclosure, many modifications and other embodiments of the inventive concept will come to mind of those skilled in the art to which this inventive concept pertains, and which are intended to be and are covered by both this disclosure and the appended claims. It is indeed intended that the scope of the inventive concept should be determined by proper interpretation and construction of the appended claims and their legal equivalents, as understood by those of skill in the art relying upon the disclosure in this specification and the attached drawings.

### LIST OF REFERENCE NUMERALS

100 Dome
102 Hole members
103 Top interior sides of dome assembly
104 Dome cover
110 Smart cage
115 Sensor array
120 Video camera assembly
120I Near infrared camera
125 Light source
125I Infrared light source
123 Audio sensor
127 Audio recorder
126 Speaker
130 Smart cage interior
131 Tag
133 Transparent divider
134 Opening
135 Container
136 Container rim
137 container top
138 container top openings
145 IVC rack
146 Vertical frame adapter
149 IVC rack vertical frame member
150 Graphical user interface
152 Food hopper
153 Transparent lid
160 Computer
170 Sensor
301 Sensor for electromagnetic waves
302 Sensor for sound waves
303 Sensor for temperature
304 Sensor for humidity
305 Sensor for ammonia levels
306 Sensor for carbon dioxide levels
307 Sensor for thermal imaging

1. A vertebrate monitoring system for a smart cage comprising:
at least one sensor array disposed on the smart cage over monitored vertebrate animals living within the smart cage;
at least one sensor disposed on the at least one sensor array adapted to, in situ, monitor and collect data from at least one or more of environmental conditions within the smart cage, vertebrate animal physiology, vertebrate animal activity, and vertebrate animal performance levels;
at least one video camera assembly disposed to record top-down views of the smart cage interior and elements therein;
at least one light source adapted to illuminate the smart cage interior at intensity and color ranges adapted for the at least one video camera assembly; and
at least one audio sensor and audio recorder adapted to collect sounds originating from within the smart cage.

2. The vertebrate monitoring system for a smart cage of claim 1, wherein a container is adapted to contain the smart cage and vertebrate monitoring system, the container slotted inside an IVC rack.

3. The vertebrate monitoring system for a smart cage of claim 1, wherein the sensors are adapted to detect at least one or more of electromagnetic waves, sound waves, temperature, humidity, ammonia levels, and carbon dioxide levels within the smart cage.

4. The vertebrate monitoring system for a smart cage of claim 1, wherein the at least one video camera assembly is operably coupled to one or more machine learning algorithms capable of identifying behaviors and health conditions based on the animal movements and interactions within the smart cage.

5. The vertebrate monitoring system for a smart cage of claim 4, wherein the machine learning algorithm includes at least one Convolutional Neural Network (CNN) adapted to identify and track specific body parts or features of animals within video footage.

6. The vertebrate monitoring system for a smart cage of claim 4, wherein the machine learning algorithm includes at least one supervised learning algorithm adapted to classify animal behaviors based on features extracted from video data.

7. The vertebrate monitoring system for a smart cage of claim 4, wherein the machine learning algorithm includes graphical tracking of animal movement within smart cages.

8. The vertebrate monitoring system for a smart cage of claim 4, wherein the machine learning algorithm includes classification and clustering algorithms adapted to track multiple animals within smart cages.

9. The vertebrate monitoring system for a smart cage of claim 1, wherein a variable adapter mechanism allows for the attachment of monitoring equipment to various types of animal cages;
a centralized data collection hub for aggregating data from multiple cages; and
a software platform for analyzing aggregated data and providing insights into the health and well-being of the animals across different cages and racks.

10. The vertebrate monitoring system for a smart cage of claim 9, wherein the variable adapter mechanism is designed to accommodate cages of different sizes and shapes.

11. A method for monitoring animal health in a cage, comprising the steps of:
collecting environmental data from at least one or more sensors disposed on or within the smart cage;
collecting, in situ, data from at least one or more of vertebrate animal physiology, and the one or more vertebrate animal's activities and performance levels within the animal cage environment;
recording video and audio data of said environmental data and said one or more vertebrate animal elements within the smart cage;
analyzing data adapted to determine the condition of animals, the smart cage environment, and animal activities within the smart cage environment, and
generating reports on the health status of the animals based on the analysis.

12. The method for monitoring animal health in a cage of claim 11, further including recording by way of at least one video camera assembly top-down views of the animal cage interior and elements therein.

13. The method for monitoring animal health in a cage of claim 11, further including illuminating by way of at least one light source the animal cage interior at an intensity adapted for at least one of the at least one camera assembly.

14. The method for monitoring animal health in a cage of claim 11, further including monitoring at least one vertebrate animal by way of at least one sensor array disposed on the animal cage and over the at least one monitored vertebrate animal.

15. The method for monitoring animal health in a cage of claim 11, further including collecting, in situ, data from at least one or more of vertebrate animal physiology, the animal cage environment, and the one or more vertebrate animal's activities and performance levels within the animal cage environment.

16. The method for monitoring animal health in a cage of claim 11, further including recording by way of at least one video camera assembly top-down views of the animal cage interior and elements therein.

17. The method for monitoring animal health in a cage of claim 11, further including analyzing the collected data including applying machine learning algorithms to identify patterns or anomalies indicative of specific health conditions or behaviors.

18. A vertebrate monitoring system for a smart cage comprising:
a sensor housing configured to encase a sensor array, the sensor housing adapted to provide mechanical protection against impact and environmental exposure;
at least one sensor disposed on said at least one sensor array adapted to, in situ, monitor and collect data from at least one or more of environmental conditions within the smart cage, vertebrate animal physiology, vertebrate animal activity, and vertebrate animal performance levels;
the sensors oriented to monitor the cage interior in situ;
at least one variable adapter mechanism configurable to interface with a plurality of IVC rack types, further adapted to protect a sensor array during smart cage insertion and removal; and
A retention mechanism selected from a group of: a spring clip, a friction-fit channel, or a magnetic latch, configured to secure the sensor array and smart cage.

19. The vertebrate monitoring system for a smart cage of claim 18, wherein a data aggregation hub is operably connected to multiple said IVC racks, the hub configured to compile data from multiple animals.

20. The vertebrate monitoring system for a smart cage of claim 18, wherein the vertebrate monitoring system further includes an animal identifier comprising at least one tag affixed to animals, each tag bearing visually legible indicia, and a machine learning algorithm configured to detect and track the indicia via top-down video footage for individual animal identification in group-housed settings.
